(19) United States
(12) Patent Application Publication
(10) Pub. No.: US 2004/0111706 A1
(43) Pub. Date: Jun. 10, 2004

(54) Analysis of latencies in a multi-node system

(76) Inventors: Jeffrey Clifford Mogul, Menlo Park, CA (US); Athicha Muthitacharoen, Cambridge, MA (US); Janet Lynn Wiener, Palo Alto, CA (US)

Correspondence Address: HEWLETT-PACKARD COMPANY, Intellectual Property Administration, P.O. Box 272400, Fort Collins, CO, 80527-2400, US

(21) Appl. No.: 10/314,100

(22) Filed: Dec. 7, 2002

(51) Int. Cl. G06F 9/44

(52) U.S. Cl. 717/127; 717/124; 717/133

(57) ABSTRACT

Analysis of latencies in a multi-node system includes creating call chains that are inferred from a temporal relationship of calls and returns between the nodes.

### BACKGROUND

Many distributed systems for Enterprise and HPTC applications, and especially for Web-based applications, are composed of a number of different components that communicate with one another. The components can run in different processes and on different processors. For example, a multi-tiered system might start with calls from Web clients that flow through an Apache Web server front-end, and then continue on to a BEA or WebSphere web application server. The web application server, in turn, makes calls to an Oracle database server, and perhaps to additional services (e.g., ERP, name service, credit card authorization).

Such complex systems can be very hard to debug, especially those exhibiting bottlenecks and other performance problems. A system integrator is not likely to have detailed knowledge about each component, each platform, and each process. Moreover, the system might be so complex that the system integrator might not know where to start debugging.

It would be desirable to identify bottlenecks in a complex system without the need for a detailed understanding of the system. An automated tool for identifying bottlenecks would be especially desirable.

### SUMMARY

According to one aspect of the present invention, latencies in a multi-node system are analyzed. The analysis includes creating call chains that are inferred from a temporal relationship of calls and returns between the nodes. Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a flow chart of a method of analyzing latencies in a multi-node system in accordance with an embodiment of the present invention.

FIG. 2 is an illustration of a simple multi-node system in accordance with an embodiment of the present invention.

FIGS. 3a-3b illustrate a method of identifying bottlenecks in accordance with an embodiment of the present invention.

### DETAILED DESCRIPTION

As shown in the drawings for purposes of illustration, the present invention is embodied in a method and machine for analyzing latencies in a multi-node system. The nodes have latencies such as compute time and I/O delays, and communications links between the nodes have latencies such as communications latency. The latencies can be identified by constructing and analyzing call chains. These call chains can be used to identify the nodes contributing to long latency of the system, without delving into the inner workings of the nodes. The nodes are treated as black-box components.

The nodes are not limited to any particular type. The nodes can be viewed at a variety of granularities, such as computers, processes, active objects (e.g., Java objects), disk drives, etc. If the nodes are computers, the communication links may include network links between the computers. If the nodes are processes, the communication links may include interprocess communication paths. If the nodes are threads, the communication links may include thread-to-thread messages. If the nodes are objects, the communication links may include object invocations and responses. There is no limitation as to the number of nodes and communication links, and the complexity of the system. However, treating the nodes as block box components is especially advantageous for large, complex systems.

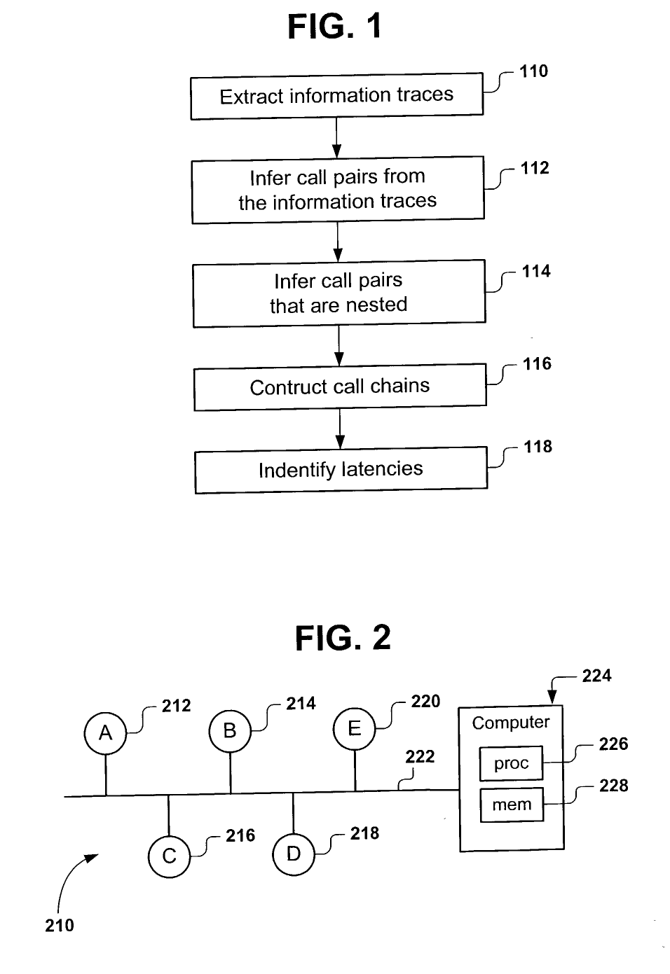

Reference is made to FIG. 1, which illustrates the method in general. Information traces are extracted from the communication links (110). Each trace includes a list of trace records. Each trace record typically contains at least the following fields: timestamp, sender-node, receiver-node, and call-or-return. The trace records might also include a sent-or-received field indicating whether the message was intercepted at the sender or receiver. Exemplary techniques for extracting the traces include passive network monitoring (for communication edges that flow between computers, on unencrypted paths), kernel instrumentation, middleware instrumentation, application instrumentation, etc.

Call pairs are inferred from the extracted information traces (112). Although calls and returns have a specific meaning within the Remote Procedure Call (RPC) model, these terms are used more generally herein. As used herein, a call represents a request sent by a source node, and a return represents a response received by the source node. A call and return may be paired if the call is sent to a destination node, and the return is received from the same destination node, after the call has been sent. Timestamps may be assigned to each call and each return to facilitate the pairings. It is not known whether the return was sent in response to the call. The causal relationship between calls and returns is inferred from their temporal relationship.

The call pairs that are nested are inferred (114). A nested pair is a call pair that temporally occurs inside a call pair at a higher level. By way of example, a call pair A/B represents a call by node A to node B, and a return from node B to node A. Similarly, a call pair B/C represents a call by node B to node C, and a return from node C to node B. Call pair B/C is nested with respect to call pair A/B if the call by node B occurs after the call by node A, and the return by node C occurs before the return by node B. Here too, the causal relationship between nested pairs is inferred from their temporal relationship.

Nested call pairs are aggregated into call chains (116). For example, call pairs B/C and B/E are nested with respect to containing pair A/B, and pair E/F is nested with respect to pair B/E. The following chains may be constructed from these nested pairs:

A->B->E->F->E->B->A. (1)

A->B->C->B->A. (2)

Each chain path has a total latency: the difference between the first and last timestamps.

In a large system, there might be many nested call pairs. Consequently, there might be a very large number of call chains. These chains simply represent possible stimuli-responses between two or more nodes; a causal relationship is not known for certain since the trace records might not contain sufficient information to determine whether the return from the last node in a chain to the first node in the chain was actually in response to a call from the first node.

The chains may be used to identify latencies in the system (118). The chains contributing the most total latency to the system can be identified, and specific calls within those chains can be identified. From these specific calls, the latency distribution at specific nodes can be computed. Thus the node or nodes responsible for most of the latency in the system can be identified. These nodes are assumed to cause the “bottlenecks” in the system.

The method can identify latencies such as compute time and I/O delays, communications latency. It can also identify other latencies, such as locks, queues, etc. The method can find both the high-latency call chains in a distributed system, and the high-latency nodes within those call chains. No a priori information about the system (e.g., historical information, semantics of the system and its internal nodes) is required. The method can be fully automated.

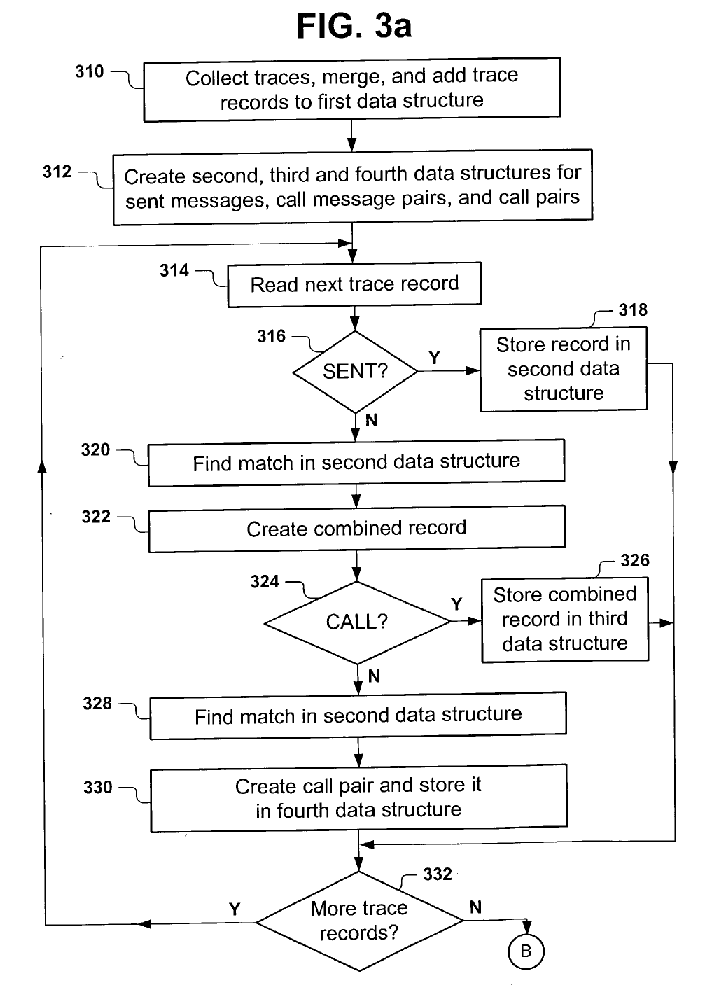

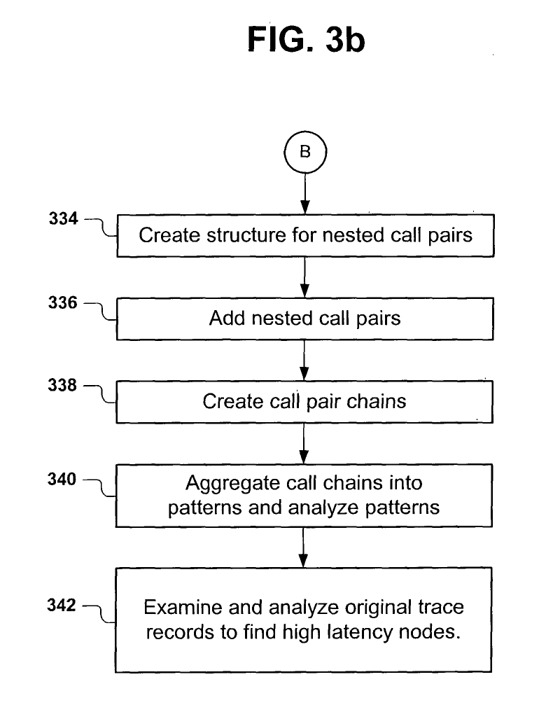

FIGS. 2 and 3a-3b illustrate a simple system 210 and an example of a method for identifying bottlenecks in the system 210. The system 210 includes five nodes: node A 212, node B 214, node C 216, node D 218, and node E 220. These five nodes 212-220 are connected to a data bus 222, which provides the communication link.

Referring to FIG. 3, traces are collected from all communication links and merged into a first data structure (310). The first data structure can be a database, a hash table, a list, etc. The records in the first data structure may be sorted by timestamp, and each entry may contain tuples of the form:

<sender, receiver, msg-type, msg-direction, timestamp>.

The field message type is either call or return, and the field message direction is either sent or received. Records in the first data structure may be indexed by time stamp.

Consider the example in Table 1. Table 1 lists sixteen trace records generated by the five nodes 212-220.

The calls and returns are identified in the first data structure; and the call pairs may be created by using the timestamps of the calls and returns to create combinations of the calls and returns (314-332). The calls and returns may be identified, and the call pairs created, via second, third and fourth data structures. The second data structure is used to match sent messages with received messages. The second data structure contains records of messages whose message direction is SENT and whose message type is either call or return. Each record in the second data structure identifies the sender, the receiving node or receiver, the message type, and the time that the message was sent. The second data structure can be eliminated if there is only one record per message. The third data structure is used to match calls and returns; it holds a call until matched with a return. The third data structure contains records of call messages that were sent by the sender and received by the receiver. Each record in the third data structure identifies the sender, the receiver, the time that sender sent the call message, and the time that the receiver received the call message. The fourth data structure contains records of call pairs.

TABLE 1

| | | | Message | Message | |
|---|---|---|---|---|---|
| Record | Sender | Receiver | Type | Direction | Timestamp |
| 1 | A | B | CALL | SENT | 00.001 |
| 2 | A | B | CALL | RECEIVED | 00.002 |
| 3 | B | C | CALL | SENT | 00.006 |
| 4 | B | E | CALL | SENT | 00.009 |
| 5 | B | E | CALL | RECEIVED | 00.010 |
| 6 | E | F | CALL | SENT | 00.011 |
| 7 | B | C | CALL | RECEIVED | 00.014 |
| 8 | E | F | CALL | RECEIVED | 00.015 |
| 9 | F | E | RETURN | SENT | 00.020 |
| 10 | F | E | RETURN | RECEIVED | 00.021 |
| 11 | C | B | RETURN | SENT | 00.025 |
| 12 | C | B | RETURN | RECEIVED | 00.026 |
| 13 | E | B | RETURN | SENT | 00.030 |
| 14 | E | B | RETURN | RECEIVED | 00.031 |
| 15 | B | A | RETURN | SENT | 00.045 |
| 16 | B | A | RETURN | RECEIVED | 00.047 |

Records in the second and third data structures may be indexed by the combination of sender and receiver and stored in ascending order by timestamp within each sender-receiver pair. Records (call pairs) in the fourth data structure may be indexed by sender and stored in ascending order by timestamp within each sender. Such indexing and ordering allows a trace to be processed in time proportional to its length. A different indexing scheme could be used, but it could cause-processing time to increase worse than linearly in the length of the trace.

The second, third and fourth data structures are created (312). These data structures may be filled with records as follows (314-332). The traces may be read in ascending timestamp order. For each trace record r1 (314), the following steps may be performed. If msg-direction=SENT (316), the record r1 is stored in the second data structure (318).

If message direction is RECEIVED, the record r1 is matched with the record r2 from the second data structure (320). If a matching record is found (the two records r1 and r2 have the same sender and receiver and the record r2 has the earliest timestamp), a combined record <r1+r2> is created (322) and the record r2 may be deleted from the second data structure to avoid matching it with any other record.

For each combined record <r1+r2>, if message type is call (324), then <r1+r2> is stored in the third data structure (326).

For each combined record <r1+r2>, if message type is return (324), then record <r1+r2> is matched (if possible) with the corresponding call record <r3+r4>, which may be deleted from the third data structure (328) to avoid matching it with another record in the future. Record <r3+r4> matches record <r1+r2> if record r1's sender is record r3's receiver, and record r1's receiver is record r3's sender, and record r3's timestamp (return-sent) is earlier than record r2's timestamp (call-received). A call pair <r1+r2+r3+r4> is created and stored in the fourth data structure (330). The call pair entries are therefore added in ascending order by return-received timestamp.

Applying these steps (314-332) to the records in Table I would produce the records shown in Tables 2-4 (if matched records are not deleted). Table 2 lists trace records with msg-direction=SENT, Table 3 lists combined SENT+RECEIVED trace records where the msg-type=CALL, and Table 4 lists the possible call pairs as derived from tables 2 and 3.

TABLE 2
Msg-direction = SENT

| Record | Sender | Receiver | Timestamp | Msg-type |
|---|---|---|---|---|
| 1 | A | B | 00.001 | CALL |
| 2 | B | C | 00.006 | CALL |
| 3 | B | E | 00.009 | CALL |
| 4 | E | F | 00.011 | CALL |
| 5 | F | E | 00.020 | RETURN |
| 6 | C | B | 00.025 | RETURN |
| 7 | E | B | 00.030 | RETURN |
| 8 | B | A | 00.045 | RETURN |

TABLE 3
Msg-type = CALL

| | | | Timestamp | Timestamp |
|---|---|---|---|---|
| Record | Sender | Receiver | Sent | Received |
| 1 | A | B | 00.001 | 00.002 |
| 2 | B | E | 00.009 | 00.010 |
| 3 | B | C | 00.006 | 00.014 |
| 4 | E | F | 00.011 | 00.015 |

TABLE 4
Call pairs

| | | Timestamp | Timestamp | Timestamp | Timestamp |
|---|---|---|---|---|---|
| | Call | CALL- | CALL- | RETURN- | RETURN- |
| Entry | pair | SENT | RECEIVED | SENT | RECEIVED |
| 1 | E/F | 00.011 | 00.015 | 00.020 | 00.021 |
| 2 | B/C | 00.006 | 00.014 | 00.025 | 00.026 |
| 3 | B/E | 00.009 | 00.110 | 00.030 | 00.031 |
| 4 | A/B | 00.001 | 00.002 | 00.045 | 00.047 |

After all of the trace records have been examined (332), a fifth data structure (e.g., a hash table) of nested call pairs is created (334). The entries may be indexed by the containing call (i.e., the call pair which has been inferred as the cause of the chain). Each call pair in the fourth data structure identifies a sender X and a receiver Y. For each call pair, all call pairs with the sender Y and both a later first timestamp and an earlier last timestamp are identified. If a call pair having a sender Y and such timestamps is nested, it is added to the fifth data structure (336). In this step, the call pairs may be added and stored in order by return-received (i.e., last) timestamp in the fourth data structure: for each call pair X/Y, only a very limited number of call pairs will have sender Y and timestamps that qualify it for nesting. The call pairs may be indexed by sender, and within the sender, sorted by return-received timestamp. Very few call pairs will match on both sender and return-received timestamp, but not be nested (because of a non-matching call-sent timestamp), so this step can be performed in one linear pass over the fourth data structure.

Consider the example shown in Table 4. The call pairs B/C and B/E are both nested within the first call pair A/B, while the call pair E/F is nested within the call pair B/E.

Nested pairs listed in the fifth data structure are combined into call chains (338). A call chain may be created by starting with a root pair, and aggregating all possible nested pairs to that root pair. Durations may be provided with the call chains. Table 5 lists the call chains constructed from the records of Table 4. Table 5 also lists the durations of the call chains.

TABLE 5

| Record | Chain | Duration |
|---|---|---|
| 1 | A->B->E->F->E->B->A | 47 |
| 2 | A->B->C->B->A | 47 |

The call chains may be aggregated into call chain patterns, and the patterns may be statistically analyzed to find the patterns that contribute most heavily to overall system performance (340). The statistical analysis could include adding up the total durations for all of the chains matching a pattern; computing the mean and standard deviation (to find paths that are highly variable in delay); etc. The statistics may be used to reduce the number of false positives and spurious inferences. False positives and spurious inferences are not likely to result in call chain patterns that occur a significant number of times.

The statistics may also be used to identify the nodes that contribute most to the latency of the system. The original traces can be analyzed to compute the latency distribution of individual nodes in the patterns that contribute most to the latency of the system. Consider the example of Table 5. Node B is part of both patterns. The latencies of specific invocations of node B “when it is called in the A->B->C->B->A pattern” can be examined instead of examining all of the invocations of node B.

The method may be performed by a computing apparatus such as a single computer or multiple computers (the method may be distributed among different computers). FIG. 2 happens to show a single computer 224 connected to the bus 222. The computer 224 includes a processing unit 226 and memory 228 encoded with a program for instructing the processing unit 226 to perform the method of FIGS. 3a-3b. The method can be performed online or offline, and it can be fully automated.

The method of FIGS. 3a-3b can be performed relatively quickly, in a single linear pass. The data structures can be hash tables, which allows for fast lookup of records, since lookup time is linear.

The method shown in FIGS. 3a-3b is but one refinement of the more general method of FIG. 1. There is no limitation as to the types of data structures, the number of passes, the ways in which call pairs are identified, how chains are constructed, etc.

The methods above assume that the timestamps in the information traces are derived from synchronized clocks. However, the traces might be derived from locations with unsynchronized clocks. If so, a margin of error (epsilon) may be allowed when comparing timestamps. Consider an example in which X is a timestamp of a call, and Y is a timestamp of a return. If X>Y but X-Y<epsilon, the return is considered to be later than the call.

In the methods described above, critical paths are found only from the limited information in the traces. However, critical paths could be annotated with useful information obtained by additional parsing of the messages. For example, such useful information might include file names obtained by parsing messages to and from file servers.

The present invention is not limited to the specific embodiments described and illustrated above. Instead, the present invention is construed according to the claims that follow.

1. A method of analyzing latencies in a system, the system including a plurality of nodes, the method comprising creating call chains that are inferred from a temporal relationship of calls and returns between the nodes.

2. The method of claim 1, wherein the call chains are created from combinations of inferred call pairs.

3. The method of claim 2, wherein the call pairs are inferred by finding matched records in the extracted information traces, and creating combinations of the matched records; wherein a record is matched if a message was sent by a sender, later received by a receiver, and later responded to by the receiver and the response received by the sender.

4. The method of claim 2, wherein the call pairs are inferred from a temporal relationship of the calls and returns.

5. The method of claim 1, wherein the call chains are inferred by:
extracting information traces between the nodes;
inferring call pairs from calls and returns in the extracted information traces;
inferring the call pairs that are nested; and
constructing the call chains from the nested call pairs.

6. The method of claim 5, wherein inferring the call pairs includes:
creating a first data structure of messages sent, each record of the first data structure indicating sender, receiver, msg-type, and timestamp;
creating a second data structure of the calls, each record of the second data structure indicating sender, receiver, sent timestamp, and received-timestamp; and
creating a third data structure of the call pairs, each record of the third data structure indicating sender, receiver, call-sent timestamp, call-received timestamp, return-sent timestamp, and return-received timestamp.

7. The method of claim 6, wherein the records in the first and second data structures are indexed by the combination of sender and receiver and stored in ascending order by timestamp within each sender-receiver pair; and wherein the records in the third data structure are indexed by sender and stored in ascending order by timestamp within each sender.

8. The method of claim 6, wherein the first and second data structures are filled by processing messages in the information traces, wherein each message is:
added to the first data structure if its message direction is sent; or
combined with a matching record (if any) in the first data structure if the message direction type is received, the combined record added to the second data structure if the message type is call.

9. The method of claim 8, wherein calls and returns are identified in the first and second data structures, and combinations of call pairs are created from the identified call pairs and added to the third data structure.

10. The method of claim 9, wherein the third data structure is filled if the message type is return and the combined record is matched with a record in the second data structure, wherein the match of the combined record and the record in the second data structure is added to the third data structure as a call pair.

11. The method of claim 6, wherein the data structures are hash tables.

12. The method of claim 5, wherein the nested call pairs are inferred from a temporal relationship of the call pairs.

13. The method of claim 5, wherein the call chains are created by aggregating nested call pairs with each containing call pair.

14. The method of claim 2, wherein inferring the call pairs includes:
creating a first data structure of records from information traces between the nodes, each record indicating sender, receiver, msg-type, and timestamp;
identifying the calls and returns in the first data structure; and
creating the call pairs by using the timestamps of the calls and returns to create combinations of the calls and returns.

15. The method of claim 14, further comprising storing the call pairs in a second data structure, the call pairs indexed by the sender and stored in ascending order within each sender.

16. The method of claim 1, further comprising identifying the chains contributing the most total latency to the system.

17. The method of claim 16, wherein the call chains are aggregated into call chain patterns, and the patterns are statistically analyzed to find the patterns that contribute most heavily to overall system performance.

18. The method of claim 17, further comprising using the statistical analysis to identify specific nodes that contribute most to the latency.

19. The method of claim 1, further comprising assigning timestamps to the calls and returns; and comparing the timestamps of the calls and returns to identify possible call pairs, the chains being constructed from the call pairs.

20. The method of claim 19, wherein the comparisons of the timestamps allow for a margin of error.

21. Computing apparatus for performing the method of claim 1.

22. An article for a processor, the article including computer memory encoded with data for instructing the processor to perform the method of claim 1.

23. A method of identifying bottlenecks in a system, the system including a plurality of nodes and communication links for the nodes, the method comprising:
extracting information traces from the communication links;
inferring call pairs from the extracted information traces;
inferring the call pairs that are nested; and
constructing chains from the nested call pairs;
whereby the chains provide information about bottlenecks in the system.

24. Apparatus for analyzing latencies in a system having multiple nodes, the apparatus comprising:
means for extracting information traces between the nodes;
means for inferring call pairs from the extracted information traces;
means for inferring the call pairs that are nested; and
means for constructing chains from the nested call pairs.

25. The apparatus of claim 24, further comprising means for performing statistical analysis on the call chains to identify bottlenecks in the system.

26. A system comprising:
a plurality of nodes; and
computing apparatus for extracting information traces that are communicated between the nodes, and for analyzing the information traces to determine latencies of the nodes, the analysis including extracting information traces from the communication links, inferring call pairs from the extracted information traces, inferring the call pairs that are nested, and constructing chains from the nested call pairs.

27. Computing apparatus comprising at least one computer for analyzing latencies in a multi-node system, the analysis including creating call chains that are inferred from a temporal relationship of calls and returns between the nodes.

28. The apparatus of claim 27, wherein the call chains are created from combinations of inferred call pairs.

29. The apparatus of claim 28, wherein the call pairs are inferred by finding matched records in the extracted information traces, and creating combinations of the matched records; wherein a record is matched if a message was sent by a sender, later received by a receiver, and later responded to by the receiver and the response received by the sender.

30. The apparatus of claim 28, wherein the call pairs are inferred from a temporal relationship of the calls and returns.

31. The apparatus of claim 27, wherein the call chains are inferred by:
extracting information traces between the nodes;
inferring call pairs from calls and returns in the extracted information traces;
inferring the call pairs that are nested; and
constructing the call chains from the nested call pairs.

32. The apparatus of claim 31, wherein inferring the call pairs includes:
creating a first data structure of messages sent, each record of the first data structure indicating sender, receiver, msg-type, and timestamp;
creating a second data structure of the calls, each record of the second data structure indicating sender, receiver, sent timestamp, and received-timestamp; and
creating a third data structure of the call pairs, each record of the third data structure indicating sender, receiver, call-sent timestamp, call-received timestamp, return-sent timestamp, and return-received timestamp.

33. The apparatus of claim 32, wherein the records in the first and second data structures are indexed by the combination of sender and receiver and stored in ascending order by timestamp within each sender-receiver pair; and wherein the records in the third data structure are indexed by sender and stored in ascending order by timestamp within each sender.

34. The apparatus of claim 32, wherein the first and second data structures are filled by processing messages in the information traces, wherein each message is:
added to the first data structure if its message direction is sent; or
combined with a matching record (if any) in the first data structure if the message direction type is received, the combined record added to the second data structure if the message type is call.

35. The apparatus of claim 34, wherein calls and returns are identified in the first and second data structures, and combinations of call pairs are created from the identified call pairs and added to the third data structure.

36. The apparatus of claim 35, wherein the third data structure is filled if the message type is return and the combined record is matched with a record in the second data structure, wherein the match of the combined record and the record in the second data structure is added to the third data structure as a call pair.

37. The apparatus of claim 31, wherein the nested call pairs are inferred from a temporal relationship of the call pairs.

38. The apparatus of claim 31, wherein the call chains are created by aggregating nested call pairs with each containing call pair.

39. The apparatus of claim 28, wherein inferring the call pairs includes:
creating a first data structure of records from information traces between the nodes, each record indicating sender, receiver, msg-type, and timestamp;
identifying the calls and returns in the first data structure; and
creating the call pairs by using the timestamps of the calls and returns to create combinations of the calls and returns.

40. The apparatus of claim 39, further comprising storing the call pairs in a second data structure, the call pairs indexed by the sender and stored in ascending order within each sender.

41. The apparatus of claim 27, further comprising identifying the chains contributing the most total latency to the system.

42. The apparatus of claim 41, wherein the call chains are aggregated into call chain patterns, and the patterns are statistically analyzed to find the patterns that contribute most heavily to overall system performance.

43. The apparatus of claim 42, further comprising using the statistical analysis to identify specific nodes that contribute most to the latency.

44. Software for causing at least one computer to analyze latencies in a multi-node system, the analysis including creating call chains that are inferred from a temporal relationship of calls and returns between the nodes.

45. The software of claim 44, wherein the call chains are created from combinations of inferred call pairs.

46. The software of claim 45, wherein the call pairs are inferred by finding matched records in the extracted information traces, and creating combinations of the matched records; wherein a record is matched if a message was sent by a sender, later received by a receiver, and later responded to by the receiver and the response received by the sender.

47. The software of claim 45, wherein the call pairs are inferred from a temporal relationship of the calls and returns.

48. The software of claim 45, wherein inferring the call pairs includes:
creating a first data structure of records from information traces between the nodes, each record indicating sender, receiver, msg-type, and timestamp;
identifying the calls and returns in the first data structure; and
creating the call pairs by using the timestamps of the calls and returns to create combinations of the calls and returns.

49. The software of claim 48, further comprising storing the call pairs in a second data structure, the call pairs indexed by the sender and stored in ascending order within each sender.

50. The software of claim 44, further comprising identifying the chains contributing the most total latency to the system.

51. The software of claim 50, wherein the call chains are aggregated into call chain patterns, and the patterns are statistically analyzed to find the patterns that contribute most heavily to overall system performance.

52. The software of claim 51, further comprising using the statistical analysis to identify specific nodes that contribute most to the latency.
